(19) United States
(12) Patent Application Publication
(10) Pub. No.: US 2025/0111009 A1
(43) Pub. Date: Apr. 3, 2025

(54) CHANGE MANAGEMENT STRATEGY IMPLEMENTATION BASED ON MACHINE LEARNING, GRAPH THEORY AND MARKOV CHAIN WITH ABSORBING STATES

(71) Applicant: INTERNATIONAL BUSINESS MACHINES CORPORATION, ARMONK, NY (US)

(72) Inventors: Pranshu Tiwari, Delhi (IN); Anuja Chakraborty, South Windsor, CT (US); Harish Bharti, Pune (IN); Saurabh Trehan, Gurgaon (IN); Rama Prasad Reddy Munagala, Coppell, TX (US); Swarnalata Patel, Morrisville, NC (US)

(21) Appl. No.: 18/479,805

(22) Filed: Oct. 2, 2023

(51) Int. Cl. G06F 17/16; G06F 17/18

(52) U.S. Cl. CPC G06F 17/16; G06F 17/18

(57) ABSTRACT

A computer-implemented method assesses an impact of a change management strategy implementation. A first change management index score is identified. A graph theory is used to compute a degree centrality and a betweenness centrality of nodes, based on an adjacency matrix. A change management strategy framework is deployed based on the degree centrality, the betweenness centrality, and a closeness in a social media chain, to transition to one of the nodes having a probability above a predetermined probability threshold of influencing a change from one state to another. Personas are created that are associated with a particular technology, the identified first change management index score, the degree centrality, and the betweenness centrality of the nodes. A Markov chain model transition matrix measures a second change management index score after a time t is measured. A change management strategy framework is altered based on a parametric regression or a polynomial regression.

### BACKGROUND

### Technical Field

The present disclosure is generally related to adopting digital transformation of emerging technologies, and more particularly, to the implementation of a change management strategy for Information Technology (IT) project delivery.

### Description of the Related Art

Change Management strategy is used to help organizations implement a change management strategy to adopt emerging technologies. Implementing a change management strategy typically includes influencing the stakeholders who can minimize a change impact of adopting the emerging technologies and reduce the change resistance. Such a change management strategy remains a challenge.

### SUMMARY

According to one embodiment, a computer-implemented method evaluates a change management implementation strategy. The impact of the change strategy is evaluated based on a change resistance index, a degree centrality, and a betweenness to evaluate projects. A change management index score is calculated based on the change implementation strategy and the change management framework used to manage change resistance. The effectiveness of the framework is measured post-implementation on specific personas. A solution framework leverages Markov's chain and parametric learning to identify the impact on each persona and attributes associated with fine-tuning the change management framework. An analysis of an absorption matrix and management re-validation changes may be performed to make adjustments in the implementation strategy.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an illustration showing the management status of various stakeholders in a network of an organization, consistent with an illustrative embodiment.

FIGS. 2A and 2B show the leveraging of a framework to build a recommendation policy for individuals to bring digital change with varying degrees of centrality in the organization, consistent with an illustrative embodiment.

FIG. 3 is an illustration of an organizational change with closeness, betweenness, and a degree score of centrality, consistent with an illustrative embodiment.

FIG. 4 is an illustration showing a persona creation used to measure a success of the change management, consistent with an illustrative embodiment.

FIG. 5 is a flowchart illustrating a computer-implemented change management strategy consistent with an illustrative embodiment.

FIG. 6 illustrates a block diagram of a computing environment in accordance with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

As used herein, the term “degree” refers to a number of edges connected to the node. The following framework may be used to calculate the degree value of each node:

c_{d}=d(nᵢ)

As used herein, the term “betweenness” refers to the state or quality of a node between two other nodes on a same path (e.g., line). A path in a network is defined as a sequence of nodes that are between two given nodes. The term “betweenness centrality” is a measure of the shortest paths within a graph that pass by the node. The betweenness centrality is relatively higher if the point serves in more links of information chains than another point that serves in fewer links of information chains. There is at least one shortest path between every pair of vertices in a graph such that either the number of edges that the path passes through in unweighted graphs or by a sum of the weights of the edges in weighted graphs is minimized. The between centrality may be calculated according to:

$${{b}_{c} = [ {\sum }_{j = 1}^{g} {g}_{j k} ( {n}_{i} ) / {g}_{j k} ) ]}^{- 1}$$

where gⱼₖ is the geodesic distance or shortest path between nodes j and k
and gⱼₖ (n)represents the number of geodesic nodes between node j and k.

As used herein, the term “closeness centrality” (c) is a measure of an average distance of a node to all of the other nodes in a graph. For example: with g being a geodesic distance

$${c}_{c} = {[ {\sum }_{j = 1}^{g} d ( {n}_{i} , {n}_{j} ) ]}^{- 1}$$

where d is a path distance between two nodes i and j.

As used herein, the term “change resistance index” (also known as Resistance to Change Parameter/Management Index Score) refers to a numerical value used to quantify the amount of resistance to change faced by individuals as well as groups within an organization. Typically, the correlation is that a higher change resistance index means there is more resistance to change than a lower change resistance index. As used herein the change resistance index score is obtained by a function (f) which transforms a vector from an n dimension - to 1.

As used herein, an “adjacency matrix” is utilized to describe a finite graph. The components of the adjacency matrix express whether the pairs of a set of nodes are adjacent in the graph.

As used herein, a “transition matrix” is a matrix used to determine the probabilities between two states. The transition matrix can be used to model stochastic systems, such as Markov chains, where a future state depends on a current state

As used herein, an “absorption matrix” is a terminology used in the context of absorbing Markov chains. For example, an absorbing state is a permanent state that cannot be changed into another state. A transient state may be changed to an absorbing state in a Markov chain. An “absorbing Markov chain” may have a plurality of transient states that can reach an absorbing state. The absorption matrix lists various personas according to their change management index scores and their absorption state. Table 1 shown herein has a range of states, with a 1 being the lowest absorption state. It is possible to change from a transient state to a permanent state in the Markov chain in a finite number of steps.

As used herein, “persona generation” is a tool used to create a representation of an ideal person for effectuating change management by adding change-related elements to each profile.

As used herein, a“predetermined probability threshold” is a threshold at which the change management strategy can effectuate the change management strategy. For example, the threshold may be the highest probability, or one of the top five probabilities, or one of the top eight probabilities, etc. This probability threshold may be determined based on the change management score.

It is to be understood that other embodiments may be used and structural or logical changes may be made without departing from the spirit and scope defined by the claims. The description of the illustrative embodiments is not limiting. In particular, elements of the illustrative embodiments described hereinafter may be combined with elements of different illustrative embodiments.

### Technical Advantages and Support

It is to be understood that some of the advantages of the present disclosure are provided herein below. However, a person of ordinary skill in the art will appreciate that additional advantages may exist in addition to those described herein.

One or more of the computed-related methodologies discussed herein may obviate a need for time-consuming data processing by the user regarding a change strategy implementation. In addition, the ability to measure the effectiveness of change implementation provides for increased efficiency. The use of a self-learning framework to auto-customize a change strategy increases the probability of success. There is an associated technical effect of reducing computing resources used by one or more devices within the system during the change implementation. Examples of such computing resources include, without limitation, processor cycles, network traffic, memory usage, storage space, and power consumption.

In an embodiment, a computer-implemented method for assessing an impact of a change management strategy implementation, the computer-implemented method includes identifying a first change management index score, using a graph theory to compute a degree centrality, and a betweenness centrality of each node a plurality of nodes based on an adjacency matrix, each of the nodes represent individuals in an organization. A change management strategy framework is deployed at a time t based on the degree centrality, the betweenness centrality, and a closeness in a social media chain for transitioning to one node of the plurality of nodes having a highest probability of influencing a change from one state to another. One or more created personas associated with the use of a particular technology, the identified first change management score, and the degree centrality and betweenness centrality of the nodes. A Markov chain model transition matrix is created to measure a second change management index score after the time “t”. An absorption matrix is used with an absorbing probability based on the created one or more personas.

The change management strategy framework is modified based on at least one of a parametric regression or a polynomial regression. The change management strategy framework is a self-learning model that automatically customizes transitioning to the one node of the plurality of nodes having a probability above a predetermined probability threshold of influencing the change from one state to another. This computer-implemented method provides for a self-learning model that evaluates the change management index score and may modify the strategy to reduce the resistance to implementing change.

In an embodiment, which can be combined with the preceding embodiment, the self-learning model automatically customizes the transition to the one node of the plurality of nodes having the highest probability above the predetermined probability threshold. The node having the highest probability to influence the change strategy is the most efficient way to effectuate the change strategy.

In an embodiment, which can be combined with one or more preceding embodiments, modifying the change management strategy framework further includes comparing the second change management index score to the first change management index score to determine whether the second change management index score is lower. The second change management index score is determined to be a success when the second change management index score is lower than the first change management score. A lower change management index score correlates to a lower resistance to change. Thus, if the second change management index score is lower, there is less resistance to change, and the implemented strategy is working. The comparison of the change management score allows for checking the effectiveness of the change management framework.

In an embodiment, which can be combined with one or more preceding embodiments, the measuring of the second change management index score time after t occurs at the end of a campaign associated with the change management strategy. The designated time of the end of a campaign can allow for checking the effectiveness of the change management strategy at different periods of the process.

In an embodiment, which can be combined with one or more preceding embodiments, the changing of the campaign associated with a change management strategy framework is based on performing at least one or more of a parametric regression or a polynomial regression. Parametric regression and/or polynomial regression will increase the accuracy of the change management index score.

In an embodiment, which can be combined with one or more preceding embodiments, the changing of the campaign associated with the change management strategy framework includes changing at least a frequency of distributing change management mailers or a frequency of trainings associated with the change management strategy framework based on the change management index score of each of the one or more personas. Increasing or decreasing mailers or training to certain individuals can further assist the implementation of a change strategy.

In an embodiment, which can be combined with one or more of the preceding embodiments, the creating of the one or more personas is based on organizational attributes comprising age, a number of years in a department, a node centrality, a digital awareness, a social media usage, and a social media history. The personas are more accurately created based on these organizational attributes, and the result is a more effective change strategy.

In an embodiment, which can be combined with one or more of the preceding embodiments, the creating of the one or more personas is additionally based on a one or more issues related to implementing the change management strategy. More detail in the persona creation results in more effective personas for the change strategy.

In an embodiment, which can be combined with one or more preceding embodiments, the creating of the one or more personas includes a mapping each persona to include an impact of the change management strategy, and rating of each persona about the change management strategy comprising one of anti-change, neutral about change, allowing change, a helper of implementing the change management strategy, or a leader of implementing the change management strategy. The mapping of the personas to include an impact of the change management strategy according to the ratings results in a more effective change management strategy.

In an embodiment, which can be combined with one or more preceding embodiments, the measuring of the second management index score is performed using one of a Lasso regression or a Ridge regression. The Lasso regression or Ridge regression enhances the prediction accuracy and interpretability of statistical models.

In an embodiment, which can be combined with one or more preceding embodiments, the creating of the Markov chain model transition matrix includes creating bins of continuous time series data, and empirically distributing and creating a transition matrix of the continuous time series data. A stationary distribution of the data is computed and compared with the empirically distributed continuous time series data. A comparison is auto-correlating between an original model and a simulated model. A persona analysis absorption matrix is used to implement a re-validation change of the data. The auto-correlation provides for more effective change management strategy.

In an embodiment, which can be combined with one or more of the preceding embodiments, the measuring a second change management index score using the Markov chain model transition matrix includes representing probabilities of transitions within the Markov chain model. The use of probabilities of transitions provides for a more accurate Markov model and more efficient implementation of a change strategy.

In an embodiment, a computer device for change management implementation strategy includes a processor, and a memory coupled to the processor. The memory stores instructions to cause the processor to perform acts including identifying a first change management index score. A graph theory is used to compute a degree centrality, and a betweenness centrality of each node of a plurality of nodes based on an adjacency matrix. The nodes represent individuals in an organization. A change management strategy framework is deployed at a time t based on the degree centrality and the betweenness centrality. A closeness in a social media chain for transitioning to one node of the plurality of nodes is determined. A probability is determined with regard to a threshold of influencing a change from one state to another. This change management strategy framework reduces the resistance to implementing change in a more efficient manner.

In an embodiment, which can be combined with the preceding embodiment, one or more personas are created that are associated with use of a particular technology, the identified first change management index score, the degree centrality, and the betweenness centrality of the nodes. A Markov chain model transition matrix is created and used to measure a second change management index score after the time t. An absorption matrix is used with an absorbing probability based on the created one or more personas. The change management strategy framework is modified based on at least one of a parametric regression or a polynomial regression. The change management strategy framework is a self-learning model that automatically customizes transitioning to the one node of the plurality of nodes having the highest probability of influencing the change from one state to another.

In an embodiment, a computer device for change management implementation strategy includes a processor and a memory coupled to the processor. The memory stores instructions to cause the processor to perform acts including identifying a first change management index score. A graph theory is used to compute a degree centrality, and a betweenness centrality of each node a plurality of nodes based on an adjacency matrix, the nodes representing individuals in an organization. A change management strategy framework is deployed at a time t based on the degree centrality, the betweenness centrality, and a closeness in a social media chain, to transition to one node of the plurality of nodes having a highest probability of influencing a change from one state to another. One or more personas are created that are associated with use of a particular technology, the identified first change management index score, the degree centrality, and the betweenness centrality of the nodes. A Markov chain model transition matrix is created and a second change management index score is measured after the time t. An absorption matrix with an absorbing probability is based on the created one or more personas. The change management strategy framework is based on at least one of a parametric regression or a polynomial regression. The change management strategy framework is a self-learning model that automatically customizes transitioning to the one node of the plurality of nodes having a probability above a predetermined probability threshold of influencing the change from one state to another. The computer device evaluates the second change management index score and may modify the strategy to reduce the resistance to implementing change.

In an embodiment, which can be combined with the preceding embodiment, the instructions cause the processor to perform additional acts of modifying the change management strategy framework by comparing the second change management index score to the first change management index score to determine whether the second change management index score is lower. The second change management index score is determined to be a success when the second change management index score is lower than the first change management score. The comparison of the change management score allows for checking the effectiveness of the change management framework.

In an embodiment, which can be combined with one or more preceding embodiments, the instructions cause the processor to perform the measuring of the second change management index score time after t occurs at an end of a campaign associated with the change management strategy The measuring of the second change management index score is based on performing at least one or more of a parametric regression and a polynomial regression. The accuracy of the change management strategy is increased as the parametric regression and polynomial regression improves the modeling between the dependent and independent variables.

In an embodiment, which can be combined with one or more preceding embodiments, the instructions cause the processor to perform the measuring of the second change management index score includes changing at least a frequency of distributing change management mailers or a frequency of trainings associated with the change management strategy framework based on the change management index score of each of the plurality of personas. The increase or decrease in mailers or training can reduce waste in unnecessary mailers and training, and can be used to pinpoint training to specific individuals.

In an embodiment, which can be combined with one or more preceding embodiments, the instructions cause the processor to create one or more personas based on organizational attributes including age, a number of years in a department, a node centrality, a digital awareness, a social media usage, a social media history. The accuracy of the personas is improved due to the aforementioned organization attributes.

In an embodiment, which can be combined with one or more preceding embodiments, the instructions cause the processor to perform the creating of the one or more personas to include a mapping of each persona to include an impact of the change management strategy. A rating of each persona about the change management strategy is performed, including one of anti-change, neutral about change, allowing change, a helper of implementing the change management strategy, or a leader of implementing the change management strategy. The ratings provide for a more accurate representation of change management personas.

In an embodiment, which can be combined with one or more preceding embodiments, the instructions cause the processor to perform the measuring of the second management index score by using a one of a Lasso regression or a Ridge regression. The Lasso regression or Ridge regression enhances the prediction accuracy and interpretability of statistical models.

In an embodiment, which can be combined with one or more preceding embodiments, the instructions cause the processor to perform the acts of creating the Markov chain model transition matrix based on creating bins of continuous time series data. An empirical distribution is created as well as a transition matrix of the continuous time series data. A stationary distribution of the data is computed and compared with the empirically distributed continuous time series data. A comparison is auto-correlated between an original model and a simulated model. A persona analysis of the absorption matrix is performed. The re-validation of the change management continuous time series data is performed. A more accurate Markov chain is created for more effective change management.

In an embodiment, a computer-implemented method assesses an impact on change strategy in an organization based on change resistance index, degree centrality and identification of change agents. The method includes creating a plurality of personas using a Markov chain model. A graph theory is used to compute a degree centrality. A betweenness centrality of each node a plurality of nodes is computed based on an adjacency matrix. The nodes represent individuals in an organization. A transition to a first state and the effectiveness of a change management strategy to move from the first state to a second state is measured. A probability of success of being transitioned to a second change management index score associated with an absorbing state is determined after a time period based on a comparison of data with a same client or different clients. The change management strategy framework is a self-learning model that automatically customizes transitioning to a node of the plurality of nodes having a probability above a predetermined probability threshold of influencing the change from one state to another. An automatic evaluation of the effectiveness of a change management strategy, and a corrective implementation to the change strategy is the result.

### Overview

The present disclosure is generally directed to a computer-implemented method and device that implements a change management strategy based on machine learning and a graph theory through the use of a Markov chain with absorbing states.

With regard to change implementation, the rate of major organizational change has accelerated dramatically in recent years. A well-known global research and advisory company reports that the average organization has undergone five enterprise changes in the past three years and 73% of organizations expect more change initiatives in the next few years.

Resistance to modern technology and a fear of an inability to implement change has adversely-impacted IT implementations. Organizations typically use a change management strategy for every IT project delivery. The change management strategy is used to help organizations adopt digital transformation and acceptance of emerging technologies. Organizations are measuring a change resistance index, and then implementing change strategies to influence the stakeholders who can minimize the change impact. The existing solutions are mostly static in nature and do not identify the correct “resistors” and “fence-sitters” who are the most influential personas and play a vital role in overcoming change resistance.

According to the present disclosure, a computer-implemented method and device assess an impact on change strategy in an organization based on a change resistance index, a degree centrality, and by identifying the change agents using machine learning, graph theory and an ergodic Markov chain. More particularly, Markov's chain is used to measure a transition to state and the effectiveness of a change management strategy to move from one state to another.

A self-learning framework customizes a strategy according to the success/probability of being absorbed to a lowest change management score after a time period. The period of time may range, for example, of a few weeks, months, or even years (e.g., five to seven years) with a same client or with different clients. The self-learning framework may use a model, and may also evaluate the change management index used along with a closeness in a social chain and help in transitioning to the node with most influence for effectuating a change. In addition, the self-learning model may facilitate automatic changes in change management mailers, trainings and other specifications based on the success of a persona.

In one or more illustrative embodiments, the present disclosure provides for facilitating automatic persona generation based on organization characteristics like age, node centrality, digital awareness, social usage and a number of issues related to processes. The present disclosure provides for using a change management framework based on a network theory to measure the effectiveness in managing change resistance.

In this overview, a brief summary of the device and computer-implemented method for change strategy includes:
(i) Calculating a Change Management Index Score;
(ii) Calculating a Degree Centrality and Betweenness based on the Adjacency Matrix Change Management Strategy Framework which needs to be deployed in time t;
(iii) Persona Creation based on (i) and (ii);
(iv) Create a Markov Chain Model transition matrix to measure success of the Change Management Score at the end of Campaign after time t;
(v) Providing a persona-based Absorption Matrix with an absorbing probability; (vi) Modify the change management strategy framework depending on Parametric Regression or Polynomial regression.

With regard to a mathematical construct and methodology used herein, the users are shown as nodes and denoted by vectors X in R^{N}. For example, the X vectors include: X₁ is age, X₂ is a number of years in department, X₃ is a job type, X₄ is a social media usage, X₅ is a social media history.

The relationship below provides for a change management score for each individual, consistent with an illustrative embodiment.

(1) A change management index score (y) for each individual is determined based on multi-dimensional vectors, including but not limited to experience, age, digital score and a sentimental score from textual comments on internal systems and external posts on social media. etc.

In a non-limiting example, the change management index score (y) may be determined by performing the following operations:
(a) Create or modify a model that includes an array of categories of issues [‘Dislike’, ‘Unhappy’, ‘not good’,‘issues’ . . . ] and a frequency w[i] is found for each for individual tweets/comments on social media applications. An internal chat messenger may be used to monitor the comments made by certain individuals in the organization, particularly those who may have been identified as possible agents of change.
(b) Obtain a sentimental score (ss) using a count of positive words (pw) minus a count of negative words (nw). For example pw−nw=ss. A positive sentimental score (pss) (more positive words than negative words) would make it more likely that a user may be an advocate for change strategy. A negative sentimental score (nss) would make the user less likely to be an advocate for change strategy.
(c) Create word embeddings to increase the efficiency and accuracy of the model for textual analysis. For example, the model may consider the positions of the embedded words. The word index and embeddings may convert the text into a numeric vector that can be used to measure the response of the Change Management Index Score. Natural language processing (NLP) based language models may be used.
(d) Identify a number of change requests raised due to the onboarding of a new product. A change request can be categorized on the following: (i) change requests that were triggered due to concomitant co-existence of existing and new processes [a]; and (ii) change requests that were triggered due to the existence of a new process [b].

(2) After determining the change management index score in (1), the computer-implemented method identifies nodes that have a high change management index score and have high closeness, degree and in betweenness.

$$y ∈ R , X ∈ {R}^{n} \qquad eq ( 1 )$$

where y is the change management score, R is a change management request, and X is a dimensional vector which includes age, digital awareness, sentiments of words used, management status, and a number of process-related tickets.

$$f : R {\to }^{n} R \qquad eq ( 2 )$$

where ƒ is a function, R (function takes a real number), n represents a number of dimensions or number of inputs, and → R meets output score is a real number (e.g., 4.25, etc.). The function ƒ converts data from an n dimension to a single dimension. As denoted mathematically, ƒ represents a function that generates a change management resistance score.

With regard to creating a Markov chain model, leveraging equation y=ƒ(\vec{x}) the calculate change management index is calculated and then a graph is plotted graph between y and x₃; Management Status.

Table 1 shows the change management states of nodes and employees, consistent with an illustrative embodiment. Bins of continuous time series data are created, and states of different nodes/individuals after a time t campaign across different IT/transformation projects. For example, there is shown a column of various change management indexes and another column of states. In the Markov chain model, there is a mapping from continuous variables to discreet scores. The discrete scores are the states shown in Table 1. The nodes may jump to different states based on the change in management index scores that occurs during implementation. The change in scores for the personas is indication as to whether the plan being implemented is working, or whether change is needed.

TABLE 1
Change Management States of Nodes/Employees/Example

| Change Management Index | State |
|---|---|
| M-N | 1 |
| N-1 N-20 | 2 |
| N-21 N-30 | 3 |
| N-31 N-41 | 4 |
| N-42 N-51 | 5 |
| N-51-N-61 | 6 |

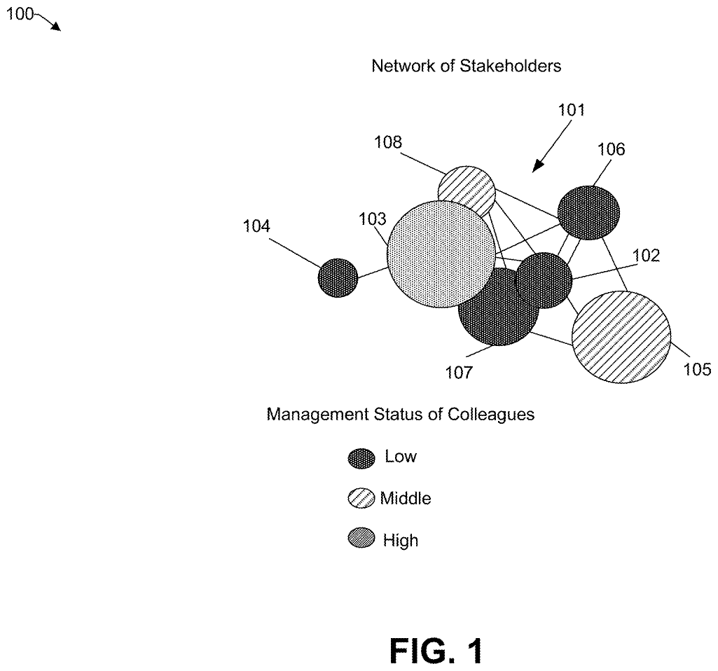

M-N is the lowest change index score, which may be the absorbing state. The plotting of the nodes may be shown in a graph similar to FIG. 1. It is understood that the plotting function cannot be performed manually due to the complexity of the operations, as the present disclosure teaches a way to automatically evaluate the change management strategy unknown heretofore.

### Example Embodiment

FIG. 1 is an illustration showing the management status 100 of various stakeholders in a network of an organization implementing a change management strategy, consistent with an illustrative embodiment. A network of stakeholders 101 are identified as nodes. The size of the nodes are differently sized in proportion according to the change management index scores. The large nodes have a higher change management index score, and the smaller nodes have a lower change management score. The shadings of the nodes are according to a low, a medium and a high range of scores. In terms of centrality, the node 103 is closer to the center of the network and has more connections than node 105, so the person represented by node 103 is more important in terms of change management, based both on a higher change management index score and a degree of centrality. In other words, the person represented by node 103 has a higher index score and more direct access to more nodes than node 105. The nodes 102, 104, 106 and 107 all have significantly lower scores based on their relative size, and their centrality is less because they are not closest to the center of the network. Node 108 is slightly larger than the nodes 102, 104,106 and 107, but the degree of centrality is lower than node 103.

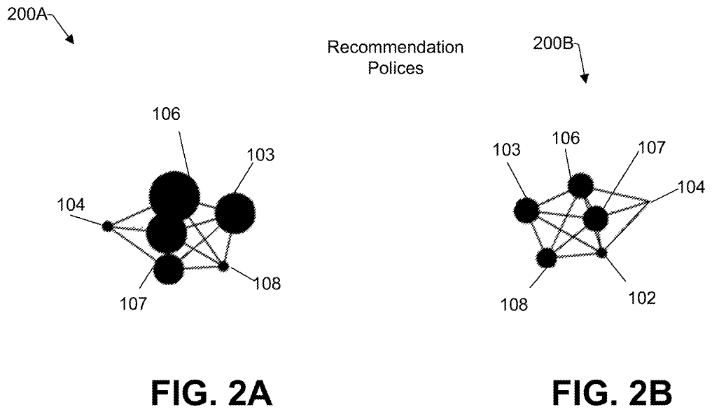

FIGS. 2A and 2B show the leveraging of a framework to build a recommendation policy for individuals to bring digital change with varying degrees of centrality in the organization, consistent with an illustrative embodiment. FIGS. 2A and 2B show the nodes identified in FIG. 1 (nodes 102, 103, 104, 106, 107, 108) with various change management scores. The nodes are samples that represent individuals. The recommendation policy may include several components including but not limited to active leadership, employee inclusion, integration of software platforms and technology. In FIGS. 2A and 2B a network theory framework is being leveraged to build the recommendation policy for the individuals who can bring the digital change with varying degrees of centrality in the organization. The differences in the nodes in FIGS. 2A and 2B are because of differences in the change management implementation strategy based on the degree, closeness and betweenness centrality of two different strategies.

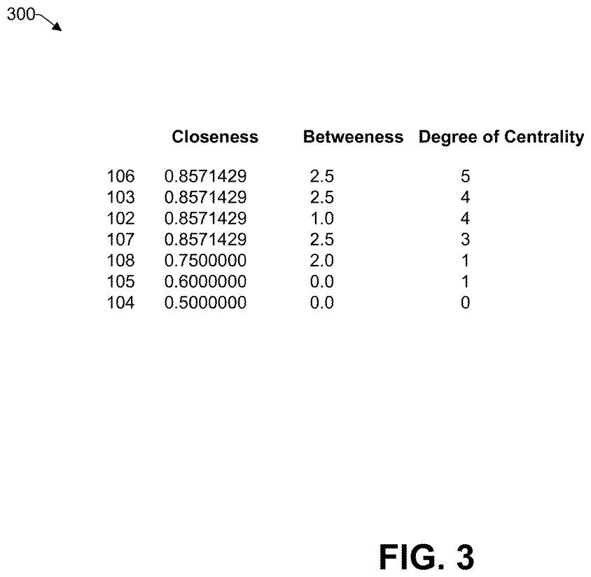

FIG. 3 is an illustration of an organizational change with closeness, betweenness, and a degree score of centrality, consistent with an illustrative embodiment. FIG. 3 shows that the node 106 has the highest amount of closeness, betweenness, and degree. The next two nodes 103 and 102 have a same closeness but a reduced degree, and a reduced betweenness compared with node 106. The remaining nodes are ranked according to at least one of closeness, betweenness and degree.

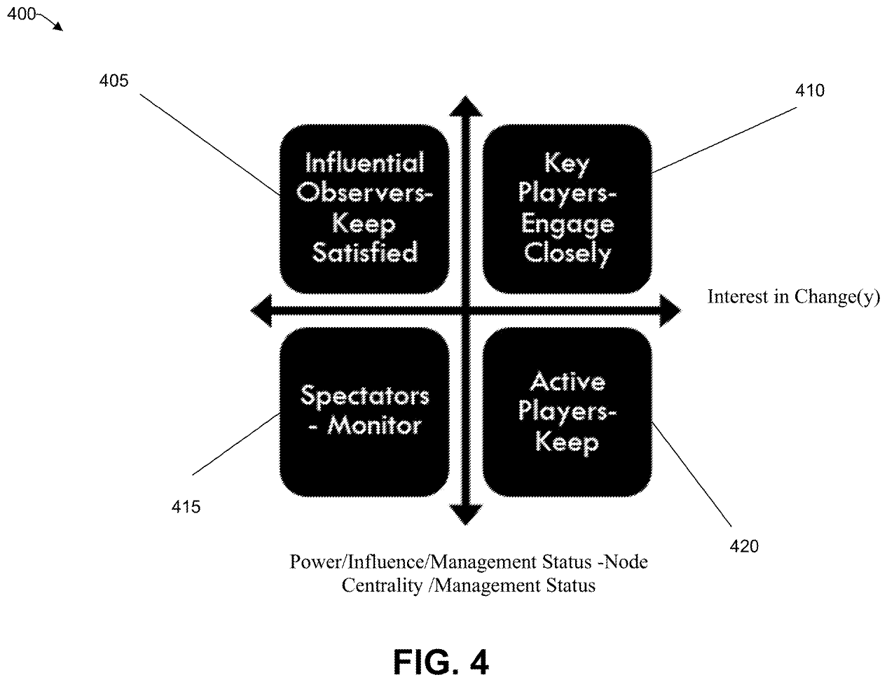

FIG. 4 is an illustration showing a persona creation used to measure a success of change management, consistent with an illustrative embodiment. Some of the personas created would include influential observers 405 (who must be satisfied), key players 410, spectators 415, and active players 420. Active players 420 may be the change practitioners, sponsors, people managers, project managers, or those impacted by the change. Key players function to contribute to change through preparing, equipping, and providing integrated strategies and plans, as well as the active participation throughout the process. Key players 410 may be stakeholders with a high interest in the success of the change implementation. Key players 410 support is an important element for the change management to be implemented.

### Example Process

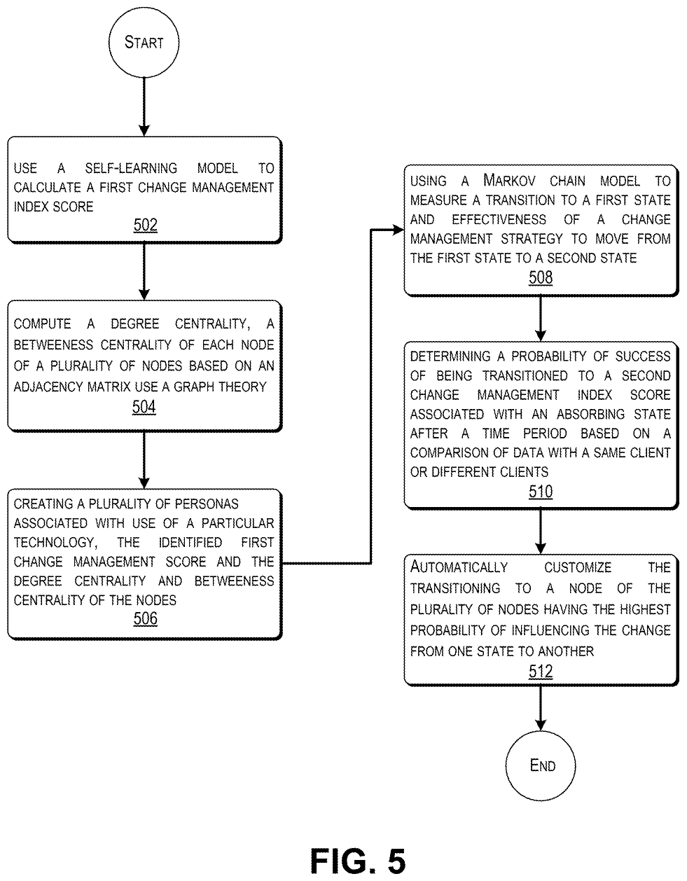

With the foregoing overview of the example architecture, it may be helpful now to consider a high-level discussion of an example process. To that end, FIG. 5 is a flowchart illustrating a computer-related method of implementing a change management strategy, consistent with an illustrative embodiment.

FIG. 5 is shown as a collection of blocks, in a logical order, which represents a sequence of operations that can be implemented in a combination thereof. It is to be understood that the computer-implemented method of the present disclosure is not limited to the flowchart of FIG. 5.

A self-learning model is provided to calculate a first change management index score (operation 502). For example, the first change management index score is a predicted resistance to change using a Lassos regression or a ridge regression. The self-learning model effectively evaluates the change management index score, and is also used in the other operations of the method to transition to a node with the highest amount of influence.

Using a graph theory, a degree centrality is computed and a betweenness centrality of each node of a plurality of nodes is based on an adjacency matrix (operation 504). The graph theory represents how individuals are connected and which individuals are closely connected to others. The graph theory may be used to find the degree of each node, the in-betweenness of the graph, the closeness of each node, and the Eigen Value of each node.

One or more personas are created that are associated with the use of a particular technology, the identified first change management score and the degree centrality and betweenness centrality of the nodes (operation 506). Persona generation is used to create a representation of an ideal person for effectuating change management by adding change-related elements to each profile. Some of the organizational attributes used in persona generation may include age, a number of years in a department, a node centrality, a digital awareness, a social media usage, a social media history. A person creation is used to measure the success of the change management strategy.

A Markov chain model is used to measure a transition to a first state and the effectiveness of a change management strategy to move from the first state to a second state (operation 508). The transition to the first state (and the second state) reflects the dynamic evolution of the effectiveness of change during IT implementation. Starting with an initial state based on change management score and social closeness score, as the change management strategy is implemented to individual nodes based on their centrality, betweenness, a state transition probability matrix is plotted.

A probability of success of being transitioned to a second change management index score associated with an absorbing state after a time period is determined based on a comparison of data with a same client or different clients (operation 510). An absorbing Markov chain may have a plurality of absorbing states. As previously discussed, it is possible to change from a transient state to a permanent state in the Markov chain in a finite number of steps. A Markov Chain based model is used to evaluate the effectivity of change.

The self-learning model automatically customizes transitioning to a node of the plurality of nodes having the highest probability of influencing the change from one state to another (operation 512). For example, if the second change management index score is lower than the first change management index score, it is to be understood that the resistance to change is lower. If an absorbing state (a state in which there is no additional transitions) is reached, then there are no additional transitions to best implement the change management strategy. The method then ends after operation 512.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

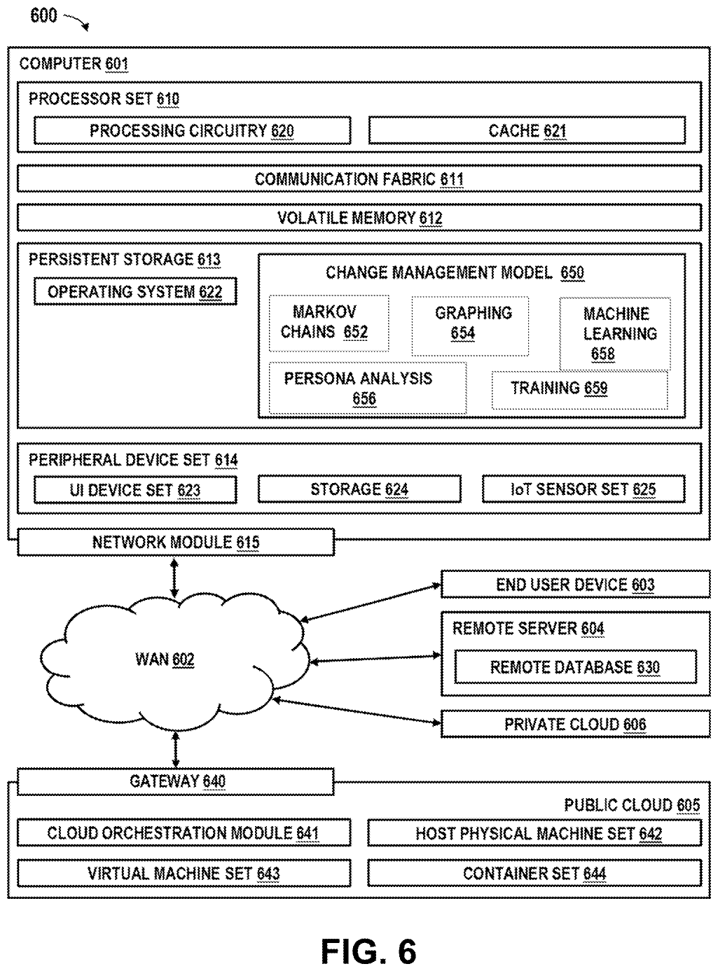

FIG. 6 illustrates a block diagram of a computing environment in accordance with an illustrative embodiment.

With reference to FIG. 6, the computing environment 600 includes an example of an environment for the execution of at least some of the computer code involved in performing the inventive methods. Computer-executable instructions for circuit performance modeling and stored in change management model 650. The Markoff chains model 652 implements the use of Markoff chains and parametric learning to analyze a transition to a state with a change strategy implemented, and to measure the effectiveness of a chain strategy from one state to another. The Graphing module 654 is used to compute the degree, in betweenness centrality, and closeness of each node for an organization. For example, the Graphing module 654 may plot an adjacency matrix G (V, E) where V are the nodes connecting individuals in the organization and E is the edge denoting a linkage between the nodes V. The machine learning model 658 assists in performing change management by drawing upon redundant common project activities and learnings from past digital transformations from the same or other organizations. The machine learning model 658 may facilitate the self-learning for change implementation. However, it is to be understood that self-learning is a broader Al concept than machine learning and may additionally (or alternatively) use self-supervised learning to create its own labels for improving the performance of the change implementation. The training model 659 is used to train and update at least the machine learning model 658 and the change management model 650.

In addition, computing environment 600 includes, for example, computer 601, wide area network 602 (WAN), end user device 603 (EUD), remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and Install Advisor Engine 662, as identified above), peripheral device set 614 (including user interface (UI) device set 623, storage 624, and Internet of Things (IoT) sensor set 625), and network module 665. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of the computing environment 600, a detailed discussion is focused on a single computer, specifically Computer 601, to keep the presentation as simple as possible. Computer 601 may be located in a cloud, even though it is not shown in a cloud in FIG. 6. On the other hand, Computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto Computer 601 to cause a series of operational steps to be performed by processor set 610 of Computer 601 and thereby effect a computer-implemented method, such that the instructions thus executed instantiates the methods specified in flowcharts and/or narrative descriptions of computer-implemented methods included in this document (collectively referred to as “the inventive methods”). These computer readable program instructions are stored in various types of computer-readable storage media, such as cache 621 and the other storage media discussed below. The program instructions, and associated data, are accessed by processor set 610 to control and direct the performance of the inventive methods. In computing environment 600, at least some of the instructions for performing the inventive methods may be stored in the install computing environment 600 in persistent storage 613.

Communication fabric 611 is the signal conduction path that allows the various components of Computer 601 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, volatile memory 612 is characterized by random access, but this is not required unless affirmatively indicated. In Computer 601, the volatile memory 612 is located in a single package and is internal to Computer 601, but, alternatively or additionally, the volatile memory may be distributed over multiple packages and/or located externally with respect to Computer 601.

Persistent storage 613 is any form of non-volatile storage for computers that is now known or to be developed in the future. The non-volatility of this storage means that the stored data is maintained regardless of whether power is being supplied to Computer 601 and/or directly to persistent storage 613. Persistent storage 613 may be a read-only memory (ROM), but typically at least a portion of the persistent storage allows writing of data, deletion of data, and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in the computing environment 600 typically includes at least some of the computer code involved in performing the inventive methods.

Peripheral device set 614 includes the set of peripheral devices of Computer 601. Data communication connections between the peripheral devices and the other components of Computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where Computer 601 is required to have a large amount of storage (for example, where Computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows Computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to Computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 603 is any computer system that is used and controlled by an end user (for example, a customer of an enterprise that operates Computer 601) and may take any of the forms discussed above in connection with Computer 601. EUD 603 typically receives helpful and useful data from the operations of Computer 601. For example, in a hypothetical case where Computer 601 is designed to provide a recommendation to an end user, this recommendation would typically be communicated from network module 665 of Computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer, and so on.

Remote server 604 is any computer system that serves at least some data and/or functionality to Computer 601. Remote server 604 may be controlled and used by the same entity that operates Computer 601. Remote server 604 represents the machine(s) that collect and store helpful and useful data for use by other computers, such as Computer 601. For example, in a hypothetical case where Computer 601 is designed and programmed to provide a recommendation based on historical data, then this historical data may be provided to Computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for assessing an impact of a change management strategy implementation, the computer-implemented method comprising:
identifying a first change management index score;
using a graph theory to compute a degree centrality and a betweenness centrality of each node a plurality of nodes, based on an adjacency matrix, wherein the nodes represent individuals in an organization;
deploying a change management strategy framework at a time t based on the degree centrality, the betweenness centrality, and a closeness in a social media chain for transitioning to one node of the plurality of nodes having a probability above a predetermined probability threshold of influencing a change from one state to another;
creating one or more personas associated with a use of a particular technology, the identified first change management index score, the degree centrality, and the betweenness centrality of the nodes;
creating a Markov chain model transition matrix;
measuring a second change management index score after the time t;
using an absorption matrix with an absorbing probability based on the created one or more personas; and
modifying the change management strategy framework based on at least one of a parametric regression or a polynomial regression;
wherein the change management strategy framework is a self-learning model that automatically customizes transitioning to the one node of the plurality of nodes above the predetermined probability threshold of influencing the change from one state to another.

2. The computer-complemented method according to claim 1, wherein the self-learning model automatically customizes transition to the one node of the plurality of nodes having a highest probability above the predetermined probability threshold.

3. The computer-implemented method according to claim 1, wherein modifying the change management strategy framework further includes comparing the second change management index score to the first change management index score to determine whether the second change management index score is lower than the first change management index score; and
identifying that the second change management index score is a success upon determining that the second change management index score is lower than the first change index management score.

4. The computer-implemented method according to claim 3, wherein the measuring of the second change management index score time after t occurs at an end of a campaign associated with the change management strategy framework.

5. The computer-implemented method according to claim 4, wherein the measuring of the second change management index score time is based on performing at least one or more of a parametric regression and a polynomial regression.

6. The computer-implemented method according to claim 5, wherein the deploying of the change management strategy framework includes changing at least a frequency of distributing change management mailers or a frequency of trainings associated with the change management strategy framework based on the second change management index score of each persona of the one or more personas.

7. The computer-implemented method according to claim 3, wherein the creating of one or more personas is based on organizational attributes comprising age, a number of years in a department, a node centrality, a digital awareness, a social media usage, and a social media history.

8. The computer-implemented method according to claim 1, wherein creating of the one or more personas for a plurality of personas includes a mapping of each persona to include an impact of the change management strategy framework, and rating of each persona regarding the change management strategy framework comprising one of anti-change, neutral about change, allowing change, a helper of implementing the change management strategy framework, or a leader of implementing the change management strategy framework.

9. The computer-implemented method according to claim 1, wherein the measuring of the second change management index score is performed using one of a Lasso regression or a Ridge regression.

10. The computer-implemented method according to claim 1, wherein creating the Markov chain model transition matrix includes:
creating bins of continuous time series data;
empirically distributing and creating a transition matrix of the continuous time series data;
computing a stationary distribution of the continuous time series data;
comparing the stationary distribution of the continuous time series data with the empirically distributed transition matrix of the continuous time series data;
auto-correlating a comparison between an original model and a simulated model;
performing a persona analysis absorption matrix; and
performing a re-validation to change the continuous time series data.

11. The computer-implemented method according to claim 1, wherein measuring a second change management index score using the Markov chain model transition matrix includes representing probabilities of transitions within the Markov chain model.

12. A computer device for change management implementation strategy comprises:
a processor;
a memory coupled to the processor, the memory storing instructions to cause the processor to perform acts comprising:
identifying a first change management index score;
using a graph theory to compute a degree centrality and a betweenness centrality of each node a plurality of nodes, based on an adjacency matrix, wherein the nodes represent individuals in an organization;
deploying a change management strategy framework at a time t based on the degree centrality, the betweenness centrality, and a closeness in a social media chain, to transition to one node of the plurality of nodes having a probability above a predetermined probability threshold of influencing a change from one state to another;
creating one or more personas associated with a use of a particular technology, the identified first change management index score, the degree centrality, and the betweenness centrality of the nodes;
creating a Markov chain model transition matrix and measuring a second change management index score after the time t;
using an absorption matrix with an absorbing probability based on the created one or more personas; and
modifying the change management strategy framework based on at least one of a parametric regression or a polynomial regression;
wherein the change management strategy framework is a self-learning model that automatically customizes transitioning to the one node of the plurality of nodes having the probability above the predetermined probability threshold of influencing the change from one state to another.

13. The computing device of claim 12, wherein the instructions cause the processor to perform additional acts comprising:
modifying the change management strategy framework by comparing the second change management index score to the first change management index score to determine whether the second change management index score is lower; and
identifying that the second change management index score is a success upon determining that the second change management index score is lower than the first change management index score; and
wherein the transitioning to the one node of the plurality of nodes has a highest probability above the predetermined probability threshold.

14. The computing device of claim 12, wherein the instructions cause the processor to perform additional acts comprising:
the measuring of the second change management index score time after t occurs at an end of a campaign associated with the change management strategy framework; and
wherein the measuring of the second change management index score time is based on performing at least one or more of a parametric regression and a polynomial regression.

15. The computing device of claim 14, wherein the deploying of the change management strategy framework includes changing at least a frequency of distributing change management mailers or a frequency of trainings associated with the change management strategy framework, the changing of the campaign is based on the second change management index score of each persona of the one or more personas.

16. The computing device of claim 12, wherein the creating of one or more personas is based on organizational attributes comprising age, a number of years in a department, a node centrality, a digital awareness, a social media usage, or a social media history.

17. The computing device of claim 12, wherein the creating of the one or more personas includes a mapping each persona to ascertain an impact of the change management strategy framework, and a rating of each persona about the change management strategy framework comprising one of anti-change, neutral about change, allowing change, a helper of implementing the change management strategy framework, or a leader of implementing the change management strategy framework.

18. The computing device of claim 12, wherein the measuring of the second change management index score is performed using a one of a Lasso regression or a Ridge regression.

19. The computing device of claim 12, wherein the instructions cause the processor to perform additional acts of:
creating the Markov chain model transition matrix based on:
creating bins of continuous time series data;
empirically distributing and creating a transition matrix of the continuous time series data;
computing a stationary distribution of the continuous time series data and comparing with the empirically distributed continuous time series data;
auto-correlating a comparison between an original model and a simulated model;
performing a persona analysis using an absorption matrix; and
performing re-validation to change the continuous time series data.

20. A computer-implemented method for assessing impact on change strategy in an organization based on a change resistance index, a degree centrality, and an identification of change agents, the method comprising:
providing a self-learning model to calculate a first change management index score;
using a graph theory to compute a degree centrality and a betweenness centrality of each node a plurality of nodes, based on an adjacency matrix, wherein the nodes represent individuals in an organization;
measuring a transition to a first state and an effectiveness of a change management strategy framework to move from the first state to a second state;
creating a plurality of personas using a Markov chain model; and
determining a probability of success of being transitioned to a change management score associated with an absorbing state after a time period, the probability of success based on a comparison of a change management data with a same client data or a different client's data;
wherein a change management strategy framework is a self-learning model that automatically customizes transitioning to a node of the plurality of nodes having a probability above a predetermined probability threshold of influencing a change from one state to another.
